(19) United States
(12) Patent Application Publication
(10) Pub. No.: US 2003/0196260 A1
(43) Pub. Date: Oct. 23, 2003

(54) Whirlpool bathtub

(75) Inventor: Paolo Pettenon, Cittadella (IT)

Correspondence Address: PEARNE & GORDON LLP, 526 SUPERIOR AVENUE EAST, SUITE 1200, CLEVELAND, OH, 44114-1484, US

(73) Assignee: SICCE S.p.A., Bassano del Grappa (IT)

(21) Appl. No.: 10/413,226

(22) Filed: Apr. 14, 2003

(30) Foreign Application Priority Data
Apr. 17, 2002 (IT) BO2002A 000206

(51) Int. Cl. A61H 33/04

(52) U.S. Cl. 4/541.6

(57) ABSTRACT

A whirlpool bathtub (1) comprises a plurality of units (2) for generating flows of water and/or air in the tub (1); each unit (2) comprising, attachable to a wall (1a) of the tub (1) with a through hole, at least: a flow generating chamber (3) with a water passage/feed opening (4), an impeller (5) for generating flows and a nozzle (6), delimiting the chamber (3), and designed to allow the directional outfeed of the flow towards the inside of the tub (1); impeller (5) drive means (7), connected to the impeller by a transmission shaft (8), and located on the outside of the wall (1a); means (9) for supplying air to the chamber (3) which are connected to the chamber (3) and designed to allow the air to be mixed with the water which can be carried into the chamber (3). Each generating chamber (3) consists of a casing (10) housing the impeller (5), the transmission shaft (8) and each drive means (7) consisting of a rotor element (11) housed in the casing (10) and a stator element (12) outside, which can be connected directly to the casing (10) using the removable connecting means (13) for connection to the casing (10).

### BACKGROUND OF THE INVENTION

The present invention relates to a whirlpool bathtub.

At present, whirlpool bathtubs comprise a plurality of units which generate flows of water and/or air, evenly distributed on the surface of the tub to obtain a whirling motion by the water intended to massage the user in the tub.

The latest generation whirlpool bathtubs have the above-mentioned units, (see U.S. Pat. Nos. 5,056,168 and 5,386,598) each comprising:

a chamber for generating the flow, attached to the inner wall of the tub, with an impeller to allow the creation of a flow of water and/or air and a nozzle for the outfeed of said flow towards the inside of the tub;

an electric motor on the outside part of the tub wall and connected, by a shaft, to the outer impeller.

For obvious safety reasons, the electric motor is isolated, externally, by a containment casing connected to the wall of the tub, and, internally, by a wall which divides and isolates it from the generating chamber. The dividing wall may be attached to the casing or to the flow generating chamber and has suitable seals.

The center of the dividing wall allows the passage of the above mentioned impeller transmission shaft.

Each of these units also has an air infeed pipe, normally connected to the upper part of the flow generating chamber, for mixing air and water in the chamber before expulsion into the tub, when required.

These flow generating units, driven independently of one another, allow optimum programming of the type of massage to be performed, but have some disadvantages.

One of these is the complexity of the units with high costs and, above all, maintenance which, when required, is extremely long and laborious due, in particular, to the number of elements present for each generating unit which, moreover, may also lead to water stagnation in the generating chamber.

Each unit must be separated both from the inside and from the outside of the tub (in this case with complex problems caused by removal of the tub or freeing of the structures which cover it), as there is a close connection between the various elements in the unit and their covers.

Maintenance must be carried out frequently, because the units contain a considerable number of sealing parts to divide and make safe the internal operating zone relative to the motor zone and, therefore, these sealing parts often need checking and substituting, in addition to the possibility of extraordinary work.

The aim of the present invention is, therefore, to overcome the above mentioned disadvantages by providing a whirlpool bathtub with extremely simple generating units and with a reduced number of constituent elements in the units, allowing rapid, simple maintenance, maintaining a high quality and performance standard.

### SUMMARY OF THE INVENTION

The aforesaid aim is fulfilled by a whirlpool bathtub comprising a plurality of units for generating flows of water and/or air in the tub. Each unit comprises, attachable to a wall of the tub with a through hole, a flow generating chamber with a water passage/feed opening, a flow generating impeller and a nozzle, delimiting the chamber, designed to allow directional outfeed of the flow to the inside of the tub. There are also impeller drive means, connected to the impeller by a transmission shaft, and located outside the wall; means for supplying air to the chamber, connected to the chamber, and designed to allow the air to be mixed with the water which can be carried into the chamber. Each generating chamber consists of a casing which houses the impeller and the transmission shaft, whilst each drive means consists of a rotor element housed in the casing and a stator element located outside, which can be directly connected to the flow generating chamber by removable connecting means for connection to the casing.

### BRIEF DESCRIPTION OF THE DRAWINGS

The technical features of the present invention, in accordance with the above mentioned aims, are set out in the claims herein and the advantages more clearly illustrated in the detailed description which follows, with reference to the accompanying drawings, which illustrate a preferred embodiment of the invention without limiting the scope of the inventive concept, and in which:

FIG. 1 is a side view, with some parts cut away to better illustrate others, of part of the whirlpool bathtub, made in accordance with the present invention, with a water and/or air flow generating unit;

FIG. 2 is an exploded perspective view of the flow generating unit illustrated in FIG. 1;

FIG. 3 is a side cross section with some parts cut away to better illustrate others, of part of the whirlpool bathtub, made in accordance with the present invention, with a water and/or air flow generating unit.

### DESCRIPTION OF THE PREFERRED EMBODIMENTS

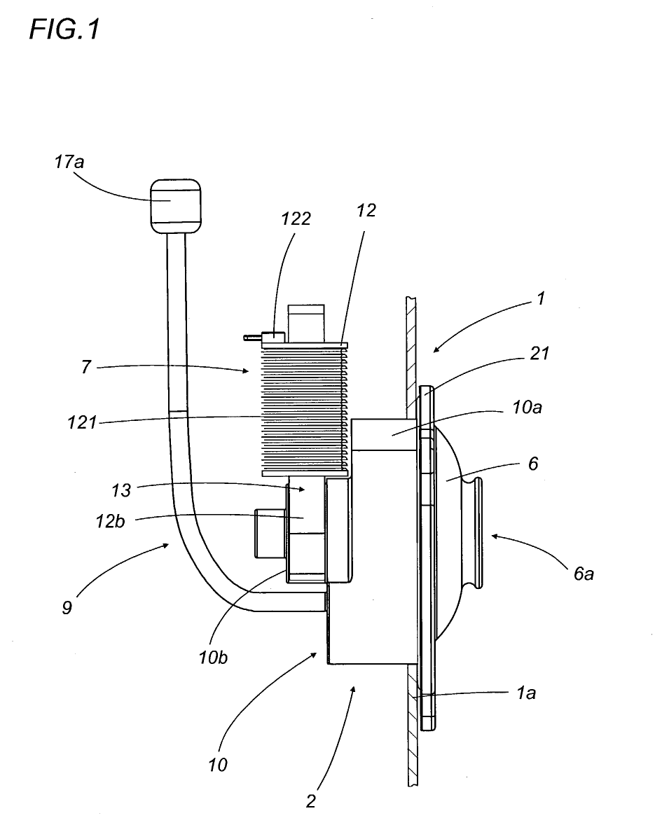

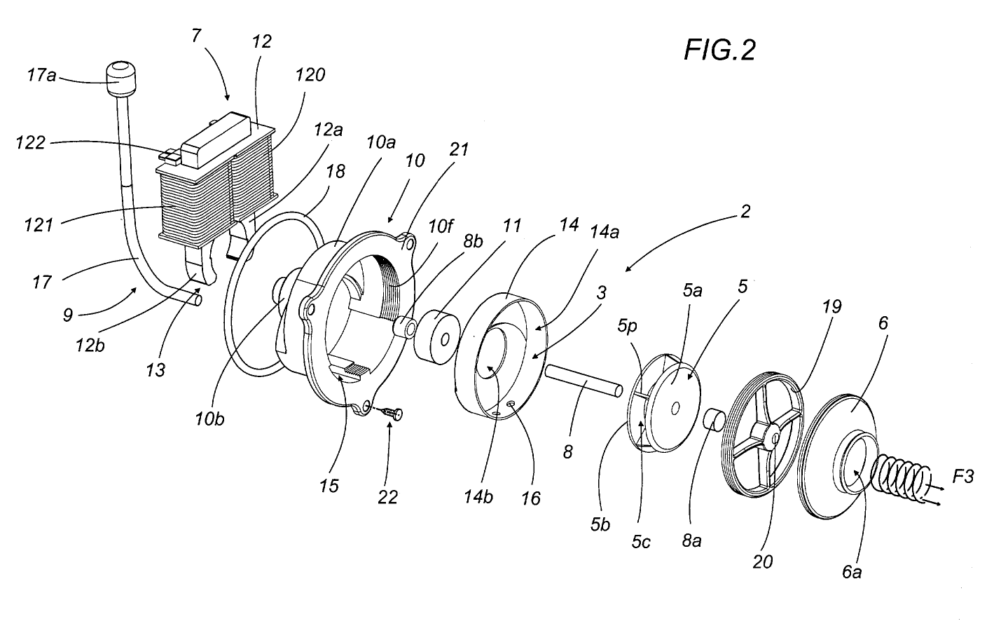

With reference to the accompanying drawings, in particular FIGS. 1 and 2, the whirlpool bathtub disclosed, labeled 1 in the parts visible and of particular interest in this description, comprises a plurality of units 2 for generating water and/or air flows, evenly distributed inside the tub 1. This produces a whirling motion in the water, intended to massage the user in the tub.

The following is a description and illustration, for the sake of simplicity, of a single flow generating unit 2, although, as already indicated, the tub may be fitted with a plurality of said units 2, without this limiting the scope of the invention disclosed.

Each of the units 2 basically comprises, attachable to a wall 1a of the tub 1 with a through hole:

a flow generating chamber 3, with at least one water passage/feed opening 4, an impeller 5 for generating the flows and a nozzle 6, delimiting the chamber 3, designed to allow directional outfeed of the flow to the inside of the tub 1;

drive means 7 for the impeller 5, connected to the impeller by a transmission shaft 8, and outside the wall 1a;

means 9 for supplying air to the generating chamber 3, connected to the chamber 3 and designed to allow the air to be mixed with the water which can be carried into the generating chamber 3.

As illustrated in FIGS. 1 and 2, the flow generating chamber 3 consists of a casing 10 which houses the impeller 5, the transmission shaft 8, and to which the nozzle 6 can be attached.

The drive means 7 also consist of a rotor element 11 housed in the casing 10 and a stator element 12 located outside and which can be connected directly to the casing 10. This stator element 12 also has removable connecting means 13 for connection to the casing 10 (described in more detail below).

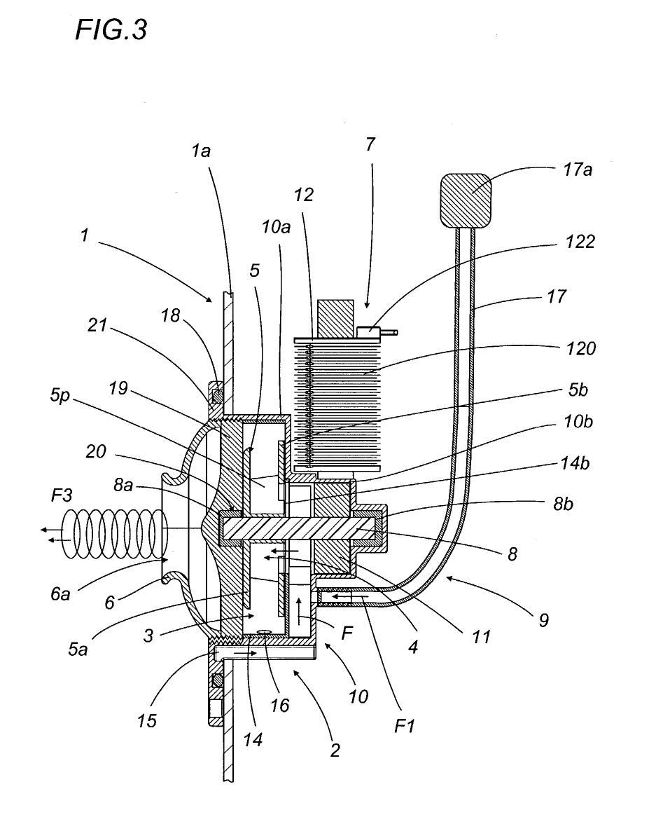

Looking more closely at the technical details, FIG. 3 also shows how the generating chamber 3 consists of the casing 10 which is a single-piece body with a front portion 10a and a rear portion 10b.

The front portion 10a, projecting outside the wall, houses the impeller 5, part of the transmission shaft 8 and the nozzle 6.

The rear portion 10b, also projecting outside the opening in the tub 1 wall 1a, supports, internally, the rotor element 11 and the other part of the shaft 8, whilst externally it can be connected to the stator drive element 12 at the zone which houses the rotor element 11.

This rear part 10b of the single-piece casing 10 forms a cylindrical seat housing the rotor element 11, that is to say, a magnetic cylinder keyed to the transmission shaft 8, the other end of which is in turn keyed to the impeller 5. The keying of the transmission shaft 8 to the rotor 11 and to the impeller 5 is of the known type and not illustrated in detail. Moreover, the ends of the transmission shaft 8 are supported by bushings 8a and 8b.

The above mentioned stator element 12 consists of a body comprising two coils 120 and 121 which can be connected, by a special connector 122, to a power supply controlled by an electronic system for the creation of pre-ordered operating cycles, of the known type and not illustrated here.

The lower section of the stator element 12 has a pair of polarity arms 12a and 12b which can be applied, stably and on both sides, at the cylindrical seat formed by the rear part 10b of the casing 10, sealed and isolating, and housing the rotor element 11. The cylindrical seat 10b may also have a supporting surface for the stator element 12 to stably support it after connection of the arms 12a and 12b on the seat 10b.

These arms 12a and 12b form both the driving connecting elements for the rotor element, and the above mentioned removable connecting means 13 between the drive unit and the chamber 3.

Continuing the description of the structure of the unit 2, the single-piece casing 10 houses an intermediate cylindrical element 14, with a front opening 14a and a rear opening 14b.

More precisely, this intermediate element 14 is inserted between the casing 10 and the impeller 5 and forms a lower zone for water infeed, together with a front opening 15 in the casing 10, forming the above mentioned opening 4 (see also the flow arrows F in FIG. 3). With this architecture, the opening 4 allows the impeller 5 to be fed from its rear zone.

The intermediate element 14 also has a plurality of through holes 16, on its lower perimeter, which allow any water left in the chamber 3 to flow out at the end of an impeller 5 operating cycle.

As illustrated again in FIGS. 1 to 3, the air supply means 9 comprise a pipe 17 connected to the lower zone of the casing 10, coinciding with the rear water passage zone 14b and 15 created by the casing 10 and the intermediate element 14. This arrangement allows air to be supplied using a vacuum created in the water passage zone 14b, 15 (see arrows F1 in FIG. 3).

The free upper end of this pipe 17 may preferably be fitted with a filter 17a for a safer quality of air supply.

The elements of which the chamber 3 consists, that is to say, the intermediate element 14, the impeller 5 and the transmission shaft 8 (together with the rotor element 11) are held in the generating chamber 3 by a ring 19. This ring 19 may have a screw connection to the casing 10 which, in turn, has an internal thread 10f.

The ring 19 also has a cross-shaped frame, at the center of which there is a rotary connecting seat 20 for the end of the transmission shaft 8. This seat 20 holds the end of the transmission shaft 8 and the support bushing 8a.

Similarly to the ring 19, the outside of the nozzle 6 is ring-shaped and can be screwed to the casing 10 using the internal connecting thread 10f.

The shape of the nozzle 6 comprises a circular central opening 6a for flow outfeed.

Thanks to this architecture, by unscrewing the nozzle 6 and the ring 19 in succession, the impeller 5, shaft 8 and rotor 11 can be removed without taking off the casing 10.

In an embodiment which does not limit the scope of application of the invention, the impeller 5 may consist of a plurality of radial vanes 5p inserted between a pair of circular walls 5a and 5b with different diameters, to create a truncated cone-shaped impeller 5 cross section.

Moreover, the radial vanes 5p are separated by chambers 5c which collect water arriving from the rear opening 4. This allows the generation of a flow at outfeed with rotating motion, that is to say, whirling (see arrows F3 in FIGS. 2 and 3) as it is fed out of the nozzle 6.

Obviously, this impeller 5 structure may vary according to the requirements of the units 2 to be fitted and the operating requirements and characteristics that they must have, without in any way limiting the present invention.

Returning to the casing 10, this may have an external flange 21 with means 22 for connection to the tub 1 wall 1a, for example, screw means.

Obviously, the casing 10 may be secured by any type of connecting means, even snap-on, according to assembly requirements on the tub 1.

In addition, the casing 10 has a single ring-shaped seal 18, inserted between the casing 10 and the tub 1 wall 1a.

A whirlpool bathtub structured in this way therefore fulfills the preset aims thanks to massage flow generating units with extremely rational construction and many advantages.

The combination of a single-piece body containing the operating elements and drive means consisting of a stator and a rotor, creates a lighter structure without supports or strengthening structures for its attachment to the tub.

This architecture also gives extremely low rotary masses and significantly reduces vibrations.

The presence of a single-piece body has allowed the creation of extremely simplified internal parts (impeller, rotor and shaft) which can be removed from the casing in a rapid, simple fashion for routine maintenance.

Similarly, this architecture allows the entire unit to be substituted or checked by simply removing and replacing the front cover of the casing.

The impeller and nozzle structure allows the generation and control of whirling flows for the massage cycles best suited to current requirements.

The invention described can be subject to modifications and variations without thereby departing from the scope of the inventive concept. Moreover, all the details of the invention may be substituted by technically equivalent elements.

What is claimed is:

1. A whirlpool bathtub (1), of the type comprising a>plurality of units (2) for generating flows of water and/or air inside the tub (1); each unit (2) comprising, attachable to a wall (1a) of the tub (1) with a through hole, at least:
a chamber (3) for generating flows with at least one water passage/feed opening (4), an impeller (5) for generating flows and a nozzle (6), delimiting the chamber (3), designed to allow the directional outfeed of the flow towards the inside of the tub (1);
drive means (7) for the impeller (5), connected to the impeller by a transmission shaft (8), and located outside the wall (1a);
means (9) for supplying air to the chamber (3), connected to the chamber (3) and designed to allow the air to be mixed with the water which can be carried into the chamber (3), wherein each generating chamber (3) of the tub (1) consists of a casing (10) housing the impeller (5) and the transmission shaft (8), and wherein each of the drive means (7) consists of a rotor element (11) housed in the casing (10) and a stator element (12) which is located outside and which can be attached directly to the casing (10), having removable connecting means (13) for connection to the casing (10).

2. The bathtub according to claim 1, wherein the generating chamber (3) consists of a single-piece casing (10) with a front portion (10a) housing the impeller (5), part of the transmission shaft (8) and the nozzle (6), and a rear portion (10b), projecting outside the opening in the tub (1) wall (1a), internally supporting the rotor element (11) and the other part of the shaft (8), and externally attachable to the stator drive element (12) at the zone housing the rotor element (11).

3. The bathtub according to claim 2, wherein the rear part (10b) of the single-piece casing (10) forms a seat which houses the rotor element (11), that is to say, a magnetic cylinder keyed to the transmission shaft (8), the other end of the latter in turn keyed to the impeller (5).

4. The bathtub according to claim 2, wherein the stator element (12) has a pair of polarity arms (12a, 12b) which can be applied stably and on both sides at a cylindrical seat (10b), sealed and isolating, housing the rotor element (11);
the arms (12a, 12b) forming the removable connecting means (13).

5. The bathtub according to claim 2, wherein the single-piece casing (10) houses an intermediate cylindrical element (14), with a front opening (14a) and a rear opening (14b), the intermediate element being inserted between the casing (10) and the impeller (5); the intermediate element (14) forming a lower zone for water infeed, together with a front opening (15) in the casing (10) creating an opening (4), for the impeller (5) so that the impeller (5) can be fed from its rear zone; the element (14) also having a plurality of through holes (16), on its lower perimeter, which allow the water to flow out at the end of an impeller (5) operating cycle.

6. The bathtub according to claims 1 and 5, wherein the air supply means (9) comprise a pipe (17) connected at the lower zone of the casing (10) coinciding with the rear water passage zone (14b; 15) created by the casing (10) and the intermediate element (14), allowing air to be supplied using a vacuum created in the water passage zone (14b, 15).

7. The bathtub according to claim 1, wherein the casing (10) has a single ring-shaped seal (18) inserted between the casing (10) and the tub (1) wall (1a).

8. The bathtub according to claims 2 and 5, wherein the intermediate element (14), impeller (5) and transmission shaft (8) are held in the generating chamber (3) by a ring (19) with a screw connection to the casing (10), the latter in turn having an internal thread (10f); the ring (19) having a cross-shaped frame at the center of which there is a rotary connecting seat (20) for the end of the transmission shaft (8).

9. The bathtub according to claims 2 and 5, wherein the outside of the nozzle (6) is ring-shaped and can be screwed to the casing (10) which has an internal connecting thread (10f); the nozzle (6) having a circular central opening (6a) for flow outfeed.

10. The bathtub according to claims 2 and 5, wherein the impeller (5) consists of a plurality of radial vanes (5p) inserted between a pair of circular walls (5a, 5b) with different diameters, creating a truncated cone-shaped impeller (5) cross-section; the radial vanes (5p) being separated by water collection chambers (5c), to allow generation of a flow at outfeed with rotational, that is to say, whirling motion.

11. The bathtub according to claims 2 and 5, wherein the outside of the nozzle (6) is ring-shaped and can be screwed to the casing (10) which has an internal connecting thread (10f); the nozzle (6) having a circular central opening (6a) for flow outfeed and the impeller (5) consisting of a plurality of radial vanes (5p) inserted between a pair of circular walls (5a, 5b) with different diameters, creating a truncated cone-shaped impeller (5) cross-section; the radial vanes (5p) being separated by water collection chambers (5c), to allow generation of a flow at outfeed with rotational, that is to say, whirling motion.

12. The bathtub according to claim 2, wherein the casing (10) has an external flange (21) with means (22) for connection to the tub (1) wall (1a).
